(19) United States
(12) Patent Application Publication
(10) Pub. No.: US 2015/0061818 A1
(43) Pub. Date: Mar. 5, 2015

(54) TEMPERATURE-DEPENDENT SWITCH COMPRISING A SNAP-ACTION DISC CLAMPED IN AT THE RIM

(71) Applicant: Thermik Geraetebau GmbH, Sondershausen (DE)

(72) Inventors: Elfriede KLASCHEWSKI, GUENSTEDT (DE); Tan Le NGUYEN, SONDERSHAUSEN (DE); René NEUMANN, BADRA (DE); Michael ZELENY, PFORZHEIM (DE); Michael KIRCH, SONDERSHAUSEN (DE); Rainer MITSCHELE, STRAUBENHARDT (DE); Hans-Christian LIEHR, SANGERHAUSEN (DE)

(21) Appl. No.: 14/463,844

(22) Filed: Aug. 20, 2014

(30) Foreign Application Priority Data
Aug. 27, 2013 (DE) 10 2013 109 29.8

(51) Int. Cl. H01H 37/54

(52) U.S. Cl. CPC H01H 37/54
USPC 337/343

(57) ABSTRACT

A temperature-dependent switch arranged with a housing has a temperature-dependent switching mechanism comprising a snap-action disc, on which at least one outer contact region and at least one inner contact region are provided. A movable contact part held on the inner contact region interacts with a first contact surface connected to a first external connection on an upper part of the housing. The at least one outer contact region is connected at least in sections permanently to a second contact surface connected to a second external connection on a lower part of the housing. The snap-action disc lifts off the movable contact part from the first contact surface depending on the temperature of the switching mechanism. The snap-action disc has at least one compensation section between the at least one outer contact region and the at least one inner contact region.

### RELATED APPLICATION

This application claims priority to German patent application DE 10 2013 109 291, filed Aug. 27, 2013, which is incorporated herein by reference.

### BACKGROUND OF THE INVENTION

### Field of the Invention

The present invention relates to a temperature-dependent switch, comprising a temperature-dependent switching mechanism and a housing accommodating the switching mechanism, which housing comprises an upper part having a first external connection and a lower part having a second external connection, wherein a first contact surface which is connected to the first external connection is provided on an inner side of the upper part, and a second contact surface which is connected to the second external connection is provided inside the lower part, wherein the switching mechanism comprises a snap-action disc, on which at least one outer contact region and at least one inner contact region are provided, on which inner contact region a movable contact part is held, which interacts with the first contact surface, wherein the at least one outer contact region is connected at least in sections permanently to the second contact surface, and wherein the snap-action disc lifts off the movable contact part from the first contact surface depending on the temperature of the switching mechanism.

Such a switch is known from DE 10 2011 119 637 A1.

The known switch comprises a pot-like lower part, which is closed by an upper part overlapping the lower part. In the interior of the switch, a temperature-dependent switching mechanism is arranged which bears a movable contact part which interacts with a stationary counter contact, which is arranged on an inner side of the upper part and forms a first contact surface.

The switching mechanism comprises a spring snap-action disc, which bears the movable contact part and presses the movable contact part against the stationary counter contact. In this case, the spring snap-action disc is supported with its rim on the inner bottom of the lower part, which forms the second contact surface. In this position, the two contact surfaces are therefore electrically conductively connected to one another via the movable contact part and the spring snap-action disc.

The external connections are made via the electrically conductive cover part, which is electrically conductively connected to the stationary counter contact, and the likewise electrically conductive lower part, on the inner bottom of which the spring snap-action disc is supported.

A bimetal snap-action disc is positioned loosely in the switching mechanism in its low-temperature position, and is arranged above the spring snap-action disc. If the temperature of the bimetal snap-action disc rises to a value above its response temperature, it presses, with its center, the movable contact part away from the stationary counter contact, for which purpose the bimetal snap-action disc presses with its rim on an insulating film, which is provided between the lower part and the upper part. The spring snap-action disc in the process jumps from its one stable geometric configuration to its other stable geometric configuration.

While, in the embodiment described to this extent, the snap-action disc is a spring snap-action disc against which a bimetal snap-action disc operates, in the case of the switch known from DE 10 2011 119 637 A1 only a bimetal snap-action disc is provided, with the result that the current flows directly through the bimetal snap-action disc which, when the switch is closed, also effects the contact pressure between the movable contact part and the stationary counter contact.

In the case of the switch known from DE 10 2011 119 637 A1, the snap-action disc is, for example, a circular disc which has an inner contact region, onto which the movable contact part is welded. In order to avoid internal warping in the snap-action disc, the inner contact region is separated from the snap-action disc by a semicircular slit, which slits extends over an angle of more than 180°.

A connecting web is integrally formed on the outer rim of the snap-action disc and, together with the rest of the rim, acts as second contact region. This connecting web serves to improve handling of the switching mechanism when said switching mechanism is assembled and inserted into the lower part. The connecting web is then welded flat onto the inner bottom of the lower part in order to ensure a permanent electrical and mechanical connection between the snap-action disc and the second contact surface inside the lower part. The second contact region is thus permanently connected to the second contact surface in the region of the connecting web and connected to the second contact surface in the region of the rim when the switch is closed.

This design provides the advantage that the material and production costs for the known temperature-dependent switch are lower than in the case of other switches because no rotary part is required as the lower part and because it is possible to dispense with the silver plating both in the case of the snap-action disc and in the case of the lower part.

As a result of the permanent galvanic connection between the snap-action disc and the second contact surface, in the case of the known switch it is ensured that the contact resistance between the snap-action disc and the lower part is very low. In this way, a potential source of faults is eliminated, which faults may come up during the final continuity test performed on a completely assembled temperature-dependent switch. Namely, it is quite possible, that owing to manufacturing tolerances the contact resistance between the lower part of the housing and the snap-action disc is so great that the finished temperature-dependent switch needs to be discarded as a reject.

Generally, temperature-dependent switches of the type mentioned at the outset are provided with snap-action discs which, however, rest with their rim loosely, i.e. freely movably, on the inner bottom of the lower part or on a shoulder running peripherally inside the lower part, with the result that the entire rim forms the outer contact region. Such switches are known, for example, from DE 43 45 350 A1. When jumping from one geometric configuration to the other geometric configuration, the snap-action disc extends until its rim lifts off from the bottom of the lower part or from the peripheral rim.

Owing to the fact that the spring snap-action disc is supported on a peripheral shoulder in the switch known from DE 43 45 350 A1, it can move, as it snaps over, with its center through the shoulder and its rim resting on the shoulder “right through” towards the bottom which is at a greater depth, i.e. snap through the rim while it at the same time extends mechanically radially outwards, which enables it to snap over without external mechanical counter forces being overcome.

These mechanical degrees of freedom during snap-over between the two geometric configurations are desirable because they have a positive effect on the life duration of the switching mechanism and the long-term stability of the switching temperature.

Although the switch known from DE 10 2011 119 637 A1 results in many advantages in respect of costs and assembling, it nevertheless has certain disadvantages in respect of the life duration of the switching mechanism and the long-term stability of the switching temperature because the snap-action disc is fixedly connected mechanically to the inner bottom of the lower part via the connecting web at a place on its circumference. This design does not enable radial stretching or unimpeded snapping through of the center of the snap-action disc, which disc, as it jumps over, is consequently subjected to external mechanical forces.

The known temperature-dependent switches serve the purpose of protecting an electrical appliance from an excessively high temperature. For this purpose, the supply current for the appliance to be protected is passed through the temperature-dependent switch, wherein the switch is coupled thermally to the appliance to be protected. At a response temperature predefined by the critical temperature of the bimetal snap-action disc, the respective switching mechanism then opens the circuit by virtue of the movable contact part being lifted off from the stationary counter contact.

In order that the switch does not close again after cooling of the appliance, it is further known to provide a self-holding resistor, preferably a PTC thermistor, in parallel with the temperature-dependent switching mechanism, which self-holding resistor is electrically short-circuited by the temperature-dependent switching mechanism when said temperature-dependent switching mechanism is closed. When the switching mechanism now opens, the self-holding resistor takes up some of the previously flowing current and is heated in the process to such an extent that it generates sufficient heat to keep the bimetal snap-action disc at a temperature above the response temperature. This operation is referred to as self-holding and prevents a temperature-dependent switch from closing again in an uncontrolled manner when the appliance to be protected cools down again.

While intrinsic warming of the snap-action disc as a result of the flowing current is often undesirable in the case of such temperature-dependent switches, switches are also known in which, in addition, a series resistor is provided which is heated by the flowing current of the appliance to be protected in a defined manner. In the case of an excessively high current flow, this series resistor is heated to such an extent that the critical temperature of the bimetal snap-action disc is reached. In addition to the monitoring of the temperature of the appliance to be protected, it is also possible in this way for the current flowing to be monitored, and the switch then has a defined current dependence.

Such switches have proved to be sufficient in everyday use. If the switches do not open at the zero crossing of an AC supply voltage or when a DC voltage is applied, arcs and flying sparks form when the movable contact part lifts off from the stationary counter contact and/or when the rim of the current-conducting snap-action disc lifts off from the second contact surface.

The arcs and sparks forming result in contact erosion and, associated therewith, in the long term in a change in the geometry of the contact surfaces of the movable contact part and the stationary counter contact, which, over time, also results in an increase in the contact resistance.

In addition to the contact erosion at the stationary counter contact and the movable contact part, contact erosion also occurs at the rim of the snap-action discs, which discs bear the movable contact part and, with their rim serving as outer contact region, produce the electrical connection to the second contact surface. Over the course of the switching cycles, this results likewise in an increase in the contact resistance as a result of damage at the rim of the snap-action discs.

These problems are intensified with the number of switching cycles even further, so that the switching behavior of the known switches is impaired over the course of time. Against this background, the life, i.e. the number of permissible switching cycles of the known switches, is limited, wherein the life also depends on the disconnection power, i.e. the current intensity of the currents switched.

DE 977 187 A therefore proposes that, in the case of a temperature-dependent switching mechanism which comprises only one bimetal snap-action disc, said bimetal snap-action disc is relieved of the load of a current flow by virtue of the fact that the movable contact part is connected to the housing of the switch via a sun wheel-shaped metal spider. In this way, the current no longer only flows through the bimetal snap-action disc, but predominantly through the metal spider.

A similar approach is taken in AT 256 225 A, in which a copper branch is provided on that surface of the bimetal snap-action disc which faces away from the stationary counter contact, the copper branch connecting the movable contact part to the housing.

The copper branch and the metal spider do not contribute to the mechanical operation of the switch; in contrast they need to be moved along by the bimetal snap-action disc during opening and closing of the switch, i.e. represent additional mechanical loading for said bimetal snap-action disc. This results in fatigue and, associated therewith, not only in an undesired shift in the switching temperature but also in an impaired opening and closing response, which severely limits the life.

In the case of these switches, the bimetal snap-action disc also needs to provide the closing pressure of the switching mechanism, but this mechanical loading can be accepted in certain switch types.

Against this background, DE 21 21 802 A proposes arranging a spring snap-action disc parallel to the bimetal snap-action disc, which spring snap-action disc contributes to the mechanical operation of the switch by virtue of it producing the closing pressure of the switching mechanism and supporting the snap-over movement of the bimetal snap-action disc both during opening and during closing. In addition, it also conducts the electric current. In this way, the bimetal snap-action disc is relieved of both mechanical and electrical loads, with the result that its life is markedly extended.

In the case of this switch, there is the problem outlined already at the outset on the basis of the switch known from DE 43 45 350 A1 of the unavoidable formation of arcs and sparking which limit the life of the known switches to a greater extent the higher the current switched.

In the switch known from DE 10 2011 119 637 A1, the contact erosion at the rim of the snap-action disc is reduced by the permanent electrical connection between the snap-action disc and the second contact surface, but nevertheless current flows when the switch is closed, i.e. when the rim of the snap-action disc is supported on the second contact surface, not only via the connecting web but also via the rim of the snap-action disc into the second contact surface, so that the rim is damaged by contact erosion during opening of the switch, which does not impair the contact resistance, but does impair the mechanical switching response and therefore the life.

### SUMMARY OF THE INVENTION

In view of the above, it is among others an object of the present invention to increase, in a manner simple in design terms, the life and/or the switching power of the known temperature-dependent switch.

According to the invention, this and other objects are one the one hand side achieved in that the outer contact region or each outer contact region rests permanently on the second contact surface.

Within the scope of the invention, “the outer contact region or each outer contact region resting permanently on the second contact surface” is understood to mean that all of that regions of the snap-action disc which are used for the electrical connection to the second contact surface rest permanently on said second contact surface, i.e. which are connected to said contact surface by the application of pressure, by adhesive bonding or by welding, and which do not lift off from the second contact surface during opening of the switch.

For the switch known from DE 10 2011 119 637 A1, the implementation of the concept on which the invention is based would mean, for example, that the snap-action disc is provided with a plurality of connecting webs which are arranged distributed along its circumference and are each welded to the bottom of the lower part. The connecting webs, of which three are arranged offset each by 120°, for example, then produce the only electrical and mechanical connection between the snap-action disc and the second contact surface. The remaining rim of the snap-action disc is without any mechanical or electrical contact.

By virtue of this measure which is simple in design terms, the problem of contact erosion at the outer contact region is solved because the or each outer contact region is completely and permanently connected to the second contact surface. There are thus no longer any sections of the outer contact region that can lift off from the second contact surface during opening of the switch, which would result in contact erosion.

At the same time, the snap-action disc is fixed symmetrically on the second contact surface, so that it demonstrates a uniform switching response, mechanically speaking. However, the snap-action disc must overcome external forces when snapping over.

It is of course possible that not every outer contact region itself is indeed welded, adhesively bonded or clamped on. It is merely important that each outer contact region rests permanently on the second contact surface. This can be achieved, for example, when six circumferentially evenly distributed connecting webs are provided, of which only every second is connected to the second contact surface. The other connecting webs are thus likewise permanently pressed fixedly onto the second contact surface, i.e. remain connected thereto even when the switch opens.

The life of the known switches is thus markedly extended.

According to the findings of the inventors of the present application, the contact erosion at the rim of snap-action discs results in the maximum switching power and the achievable switching cycle number being limited to a greater extent than as a result of the contact erosion at the stationary counter contact and the movable contact part. Merely improving the contact erosion of the rim of the current-conducting snap-action discs already makes it possible, contrary to expectations, to increase the life of a temperature-dependent switch.

According to one object, the snap-action disc comprises at least one compensation section between the at least one or each outer contact region and the at least one or each inner contact region.

Snap-action discs of the type used here are slightly curved discs with a center that is slightly raised in relation to the rim. The snap-action discs are generally round, circular, oval or similarly rounded. Bimetal snap-action discs have a high temperature setting at which they are convex in one view while, in the same view they appear to be concave when they are in their low temperature setting.

Spring snap-action discs, on the other hand, have two mechanically stable geometric settings or configurations which, depending on the view, appear to be convex or concave.

Snap-action discs snap over from their one configuration into the other configuration by virtue of their center so to speak moving right through the rim, which attempts in the process to perform a radial extending movement. If the rim is fixedly clamped in, the snap-over movement takes place by virtue of internal deformations whilst overcoming internal forces. These internal deformations and the internal forces occurring in the process result in mechanical loading and aging of the snap-action discs, which limits the life of the switches provided with said snap-action discs.

In order to avoid or at least to significantly reduce the occurrence of the internal deformations and internal forces when the snap-action disc is at least partially mechanically fixed at its rim, in accordance with the invention compensation sections are now provided within the snap-action disc, which compensation sections permit mechanical deformation.

Within the scope of the present invention, a “compensation section” of the snap-action disc is therefore understood to mean a region that so to speak is flexible or resilient in the radial direction. A compensation section of the snap-action disc enables a radially deflecting or expansion movement within the snap-action disc although the outer contact region cannot be moved or move radially outwards with respect to the second contact surface. This property of a compensation section is provided owing to its structure, i.e. its geometry and/or its connection to the snap-action disc, to the outer and/or the inner contact region. A compensation section can therefore also be referred to as an expansion structure.

The outer contact region can be in the form of an outer ring, for example, which is connected to the central region of the snap-action disc via a plurality of webs, with the inner contact region adjoining said central region radially on the inside. The outer contact region is in this case clamped onto the second contact surface. If the inner contact region of the snap-action disc bearing the movable contact part now snaps over together with the central region, the webs are deformed temporarily by performing a deflecting movement and/or being compressed in a resilient manner. They therefore perform a compensating movement, which movement relieves the central region of the snap-action disc of the mechanical loading and therefore slows down the aging processes.

A comparable compensation structure can alternatively or additionally also be provided between the inner contact region and the central region of the snap-action disc.

By virtue of the measure of compensation sections which is simple in design, the snap-action disc does not need to overcome any external forces when it snaps over because the snap-action disc performs a compensating movement in the radial direction between the outer contact region and the inner contact region because the compensation section is resilient, for example. The snap-action disc can therefore expand internally radially during opening and closing of the switch without external forces needing to be overcome in the process.

While this measure on its own also achieves the object addressed by the invention, in particular the combination of these two measures results in the problems known from the prior art and only solved individually to date being overcome.

If the snap-action disc, as in the case of the switch known from DE 10 2011 119 637 A1, is welded to the second contact surface via a connecting web emerging from the rim, this results in mechanical problems without the contact erosion at the rim of the snap-action disc being entirely eliminated.

Owing to the fact that only a single connecting web is provided which is additionally fixedly connected to the snap-action disc and welded flat onto the second contact surface, no radial deflecting movement can be permitted. The snap-action disc instead bends asymmetrically upwards at its circumferential section which is free from the connecting web, which is geometrically problematic and in the long run results in severe mechanical loading.

If the bimetal snap-action disc, as in the switches known from DE 21 21 802 A or DE 43 45 350 A1, has a current-conducting spring snap-action disc assigned to it which is not mechanically fixed at its rim, this results in contact erosion at the rim of the snap-action disc, which is associated with the abovementioned problems.

When the bimetal snap-action disc, as in the case of the switches known from DE 977 187 A or AT 256 225 A, has a current-conducting connection assigned to it which connects the movable contact part to the second contact surface, the contact erosion is reduced, but the bimetal snap-action disc is subjected to excessive mechanical loading because it needs to move along with the copper branch or metal spider.

Some or all of these and/or other problems are solved by the novel switch in a manner simple in design terms.

The advantage of the compensation sections is provided in particular in connection with snap-action discs which are fixed mechanically at their rim at least such that they are connected symmetrically and permanently both mechanically and electrically to the second contact surface so that no contact erosion can take place at the rim.

While the snap-action disc itself can be the bimetal snap-action disc, it is preferred if the snap-action disc is a spring snap-action disc with a bimetal snap-action disc assigned to it, said bimetal snap-action disc being held on the movable contact part.

It is advantageous here that the bimetal snap-action disc does not need to exert the mechanical closing pressure, nor does it need to conduct the operating current of the appliance to be protected.

According to another object, the bimetal snap-action disc is held captively with play on the contact part.

Owing to the fact that the spring snap-action disc, the bimetal snap-action disc and the movable contact part now form one unit, the switching mechanism can be fitted and interposed as a separate semi-finished part, wherein separate testing of the switching mechanism is also possible since the bimetal snap-action disc is held captively but is correspondingly loose so that it can deform unimpeded between its low temperature position and its high temperature position.

With this measure, it is further advantageous that the bimetal snap-action disc can be fitted and fixed easily to the movable contact part without the bimetal snap-action disc being subjected to mechanical stresses in its central region.

Such mechanical stresses should be avoided as far as possible in many applications with bimetal snap-action discs because due to these mechanical stresses the switching response of the bimetal snap-action disc cannot be set reproducibly or shifts unpredictably.

A bimetal snap-action disc jumps between its low temperature position and its high temperature position above the critical temperature initially gradually when the critical temperature is approached; this is referred to as the bimetal snap-action disc creeping.

If the bimetal snap-action disc is subjected to mechanical loading during this creeping process, this can result in the bimetal snap-action disc aging more quickly and its critical temperature shifting, both of which are often undesirable during use.

Further, the bimetal snap-action disc may be arranged between the spring snap-action disc and the first contact surface.

In this case, it is advantageous for the bimetal disc to be above the spring snap-action disc, so to speak, with the result that there is space beneath the spring snap-action disc to connect the or each outer contact region to the second contact surface.

On the other hand side, the bimetal snap-action disc may be arranged on that side of the spring snap-action disc which points away from the first contact surface.

It is advantageous here that the bimetal disc is so to speak beneath the spring snap-action disc, with the result that the spring snap-action disc is above the bimetal snap-action disc and shields the latter from flying sparks which can arise between the stationary counter contact and the movable contact part during opening of the switch. This protective function of the spring snap-action disc, according to the findings of the inventors, is particularly effective when the spring snap-action disc is permanently connected to the second contact surface in the outer contact region.

According to one object, the outer contact region or each outer contact region is connected permanently to the second contact surface by means of clamping, wherein preferably the movable contact part is clamped fixedly on the at least one inner contact region.

Fixed clamping or clamping-in ensures a good mechanical and electrical connection of the inner and outer contact region so that damage as a result of opening contact surfaces cannot arise there.

The outer contact region or each compensation section may be resilient in the radial direction, whereby the or each outer and/or inner contact region may be formed on a radially extending web, which may be connected to a central region of the snap-action disc exclusively via a compensation section.

In this case it is advantageous that the compensating movements during snap-over can be predetermined by the structure in a manner which is simple in design terms, for example by virtue of the fact that the compensation section is in the form of an upwardly arched section between the outer or inner contact region and the central region of the snap-action disc.

According to a still further object, at least three webs are provided, wherein preferably the outer and/or inner contact regions are connected to form a ring.

It is advantageous here that, although a large outer and/or inner contact region is provided so that the current flows uniformly through the snap-action disc, via the webs a resilient compensating movement can be set in a manner which is simple in design terms.

According to another object, the outer and/or inner contact region is in the form of a closed ring, which is connected to a central region of the snap-action disc via a compensation section, wherein the compensation section has at least one outer slit extending in the circumferential direction and at least one inner slit extending in the circumferential direction, wherein the two slits partially overlap one another in the circumferential direction, and preferably the two slits are connected to one another by a slit extending from the inside outwards, wherein further preferably at least three outer and three inner slits are provided.

In this way, a resilient structure is provided in the snap-action disc, which resilient structure permits the compensating movements without any severe material deformations because expansion into the slits is possible.

For the compensation section on the outer contact region, the inner slit may extend over an angular range which is at most half the size of the angular range over which the outer slit extends, wherein for the compensation section on the inner contact region the inner slit may extend over an angular range which is at most the same size as the angular range over which the outer slit extends.

This relationship between the circumferential extensions of the slits with respect to one another results, in accordance with the findings of the inventors of the present application, firstly in sufficient mechanical stability for the snap-action disc, but secondly permits the required compensating movements without any problems.

The novel switch may be provided with a parallel resistor for self-holding and/or with a series resistor for defined current dependence.

Further advantages result from the description and the attached drawing.

It goes without saying that the features mentioned above and yet to be explained below can be used not only in the respectively cited combination, but also in other combinations or on their own without departing from the scope of the present invention.

### BRIEF DESCRIPTION OF THE DRAWINGS

Embodiments of the invention are illustrated in the attached drawing and will be explained in more detail in the description below. In the drawing:

FIG. 1 shows a schematic, sectioned side view of a temperature-dependent switch in the closed state;

FIG. 2 shows an enlarged detail of the switch shown in FIG. 1 in the region of the shoulder on which the rim of the spring snap-action disc rests, with an embodiment for the compensation sections;

FIG. 3 shows the spring snap-action disc shown in FIG. 2 in a schematic plan view;

FIG. 4 shows, in an illustration as in FIG. 3, a second embodiment of the spring snap-action disc; and

FIG. 5 shows, in an illustration as in FIG. 3, a third embodiment of the spring snap-action disc.

### DESCRIPTION OF PREFERRED EMBODIMENTS

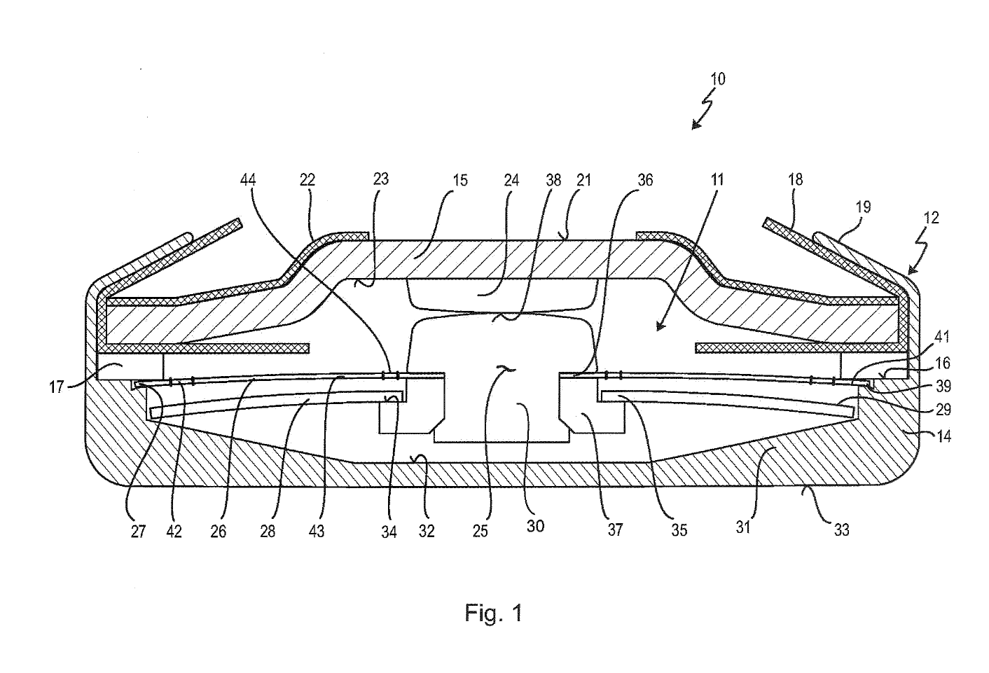

FIG. 1 shows a schematic side view of a temperature-dependent switch 10 which is circular in plan view and which comprises a temperature-dependent switching mechanism 11, which is arranged in a housing 12.

The housing 12 comprises a pot-like lower part 14, which is closed by an upper part 15. A peripheral, stepped shoulder 16 is provided in the lower part 14, with a spacer ring 17 being arranged on said shoulder, the upper part 15 resting on said spacer ring with an insulating film 18 interposed.

By its raised vertical rim 19 bent inwards, the lower part 14 clamps the upper part 15 onto the spacer ring 17 and said spacer ring onto the peripheral shoulder 16.

The lower part 14 and the upper part 15 are manufactured from an electrically conductive material, in the embodiment shown, for which reason the insulating film 18 is provided, which electrically insulates the lower part 14 and the upper part 15 from one another.

A further insulating cover 22 is provided on an outer side 21 of the upper part 15, while a stationary counter contact 24 is arranged on an inner side 23 of the upper part 15.

A movable contact part 25 borne by the switching mechanism 11 interacts with the stationary counter contact 24.

The switching mechanism 11 comprises a spring snap-action disc 26, which is clamped in with its rim 27 permanently between the spacer ring 17 and the shoulder 16, with the result that it produces a permanent electrically conductive connection there.

A bimetal snap-action disc 28 having two geometric temperature positions, the low temperature position shown in FIG. 1 and a high temperature position (not shown), is provided below the spring snap-action disc 26, i.e. on its side facing away from the stationary counter contact 24.

The bimetal snap-action disc 28 is positioned with its rim 29 freely above a wedge-shaped, peripheral shoulder 31, which is formed on an inner bottom 32 of the lower part 14.

Further, the lower part 14 has an outer bottom 33, which, together with the outer side 21 of the upper part 15, is used for the external connection of the switch 10 shown in FIG. 1.

The bimetal snap-action disc 28 is supported on a peripheral shoulder 34 of the contact part 25 with its center 35.

The spring snap-action disc 26 is permanently connected, with an inner contact region 36 in its center, to the movable contact part 25, for which purpose a ring 37 is pressed onto pin 30 of said contact part, which pin protrudes through the two snap-action discs 26 and 28, with the shoulder 34 also being formed on said ring 37.

The stationary counter contact 24 forms a first contact surface 38, which interacts with the movable contact part 25 and, via the latter, with the inner contact region 36 of the spring snap-action disc 26 and is connected to the outer side 21 of the upper part 15, i.e. to the first external connection, via said upper part 15.

The shoulder 16 forms a second contact surface 39 for an outer contact region 41 at the rim 27 of the spring snap-action disc 26, which outer contact region is mechanically and electrically connected permanently to the second contact surface 39, which is connected to the outer side 33 of the lower part 14, i.e. to the second external connection, via said lower part 14.

Adjoining the outer contact region 41 radially on the inside, the spring snap-action disc 26 comprises a compensation section 42, which connects the outer contact region 41 to a central region 43 of the spring snap-action disc 26, which central region is connected to the inner contact region 36 via a further compensation section 44.

In this way, the inner and outer contact regions 36 and 41 are clamped in fixedly by a respective clamp, i.e. permanently connected mechanically and electrically, with the result that sparks and/or arcs cannot form in these regions so that contact erosion is avoided.

In order nevertheless to provide the possibility to the spring snap-action disc 26 of being able to expand mechanically at the time at which it snaps over, the radially resilient compensation sections 42 and 44 are provided, as is mentioned further below.

In the closed switch position of the switch 10 shown in FIG. 1, the movable contact part 25 is pressed by the spring snap-action disc 26 against the stationary counter contact 24. Owing to the fact that the electrically conductive spring snap-action disc 26 is connected with its rim 27 to the lower part 14, which in this case acts as second counter contact of the switching mechanism 11, an electrically conductive connection is thus produced between the two external connections 21, 33.

If the temperature in the interior of the switch 10 now increases beyond the response temperature of the bimetal snap-action disc 28, said bimetal snap-action disc transfers from the convex configuration shown in FIG. 1 into a concave configuration in which its rim 29 moves upwards in FIG. 1 so that, from below, it comes into a bearing arrangement with the rim 27 of the spring snap-action disc 26.

In the process, the bimetal snap-action disc 28 presses with its center 35 on the shoulder 34 and thus lifts off the movable contact part 25 from the stationary counter contact 24.

The spring snap-action disc 26 can be a bi-stable spring disc which is geometrically stable even in the open position of the switch, with the result that the movable contact part 25 does not come into a bearing arrangement again with the stationary counter contact 24 even when the rim 29 of the bimetal snap-action disc 28 is no longer pressing against the rim 27 of the spring snap-action disc 26.

If the temperature in the interior of the switch 10 now decreases again, the rim 29 of the bimetal snap-action disc 28 moves downwards and comes into a bearing arrangement with the wedge-shaped shoulder 31. With its center 35, the bimetal snap-action disc 28 then presses against the spring snap-action disc 26 from below and presses said spring snap-action disc back into its other geometrically stable position, in which, as shown in FIG. 1, it presses the movable contact part 25 against the stationary counter contact 24.

In the present embodiment, the switching mechanism 11 has, in addition to the bimetal snap-action disc 28, the current-conducting spring snap-action disc 26, wherein it is also possible for only the bimetal snap-action disc 28 to be provided in the switching mechanism 11, which bimetal snap-action disc would then be clamped in with its rim 29 below the peripheral ring 17 and would have the contact regions 36 and 41 as well as the compensation sections 42 and 44.

It is also possible to arrange the bimetal snap-action disc 28 above the spring snap-action disc 26.

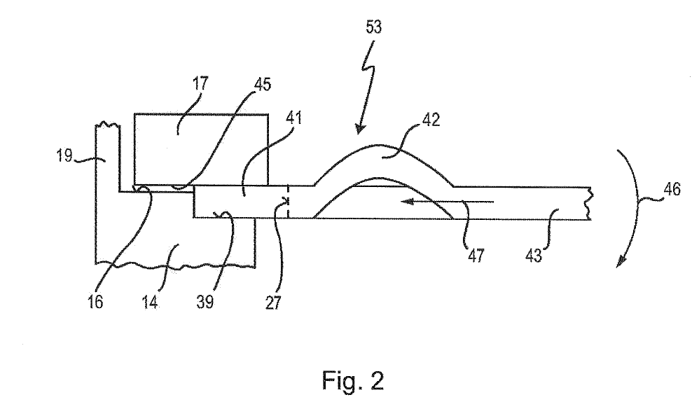

FIG. 2 shows an enlarged detail of the switch 10 shown in FIG. 1 in the region of the shoulder 16. It can be seen that the spacer ring 17 presses the outer contact region 41 onto the second contact surface 39, which is in the form of a deeper step on the shoulder 16. A gap 45 is illustrated with excessively large dimensions between the spacer ring 17 and the shoulder 16.

The compensation section 42 is in the form of an upwardly arched section between the central region 43 and the outer contact region 41, which are at approximately the same height. When the spring snap-action disc 26 snaps over, the central region 43 moves along the arrow 46 downwards and the compensation section 42 is temporarily compressed radially. The central region 43 can thus temporarily expand radially outwards along the arrow 47.

In this way, the central region 43 of the spring snap-action disc 26 does not undergo any mechanical loading during snap-over, which is associated with the advantages discussed in detail at the outset.

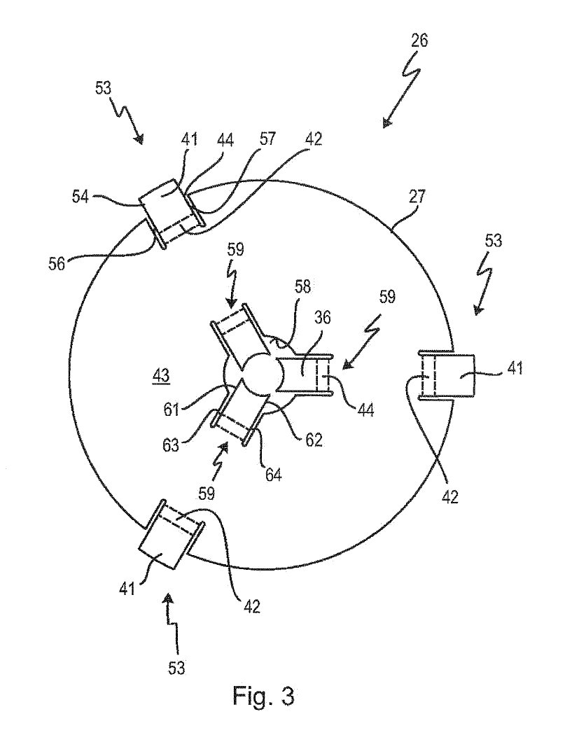

In order that the compensation section 42 can perform these movements, it is formed on a web 53, as also shown in FIG. 3, which shows a schematic plan view of a first embodiment of the spring snap-action disc 26 shown in FIG. 2.

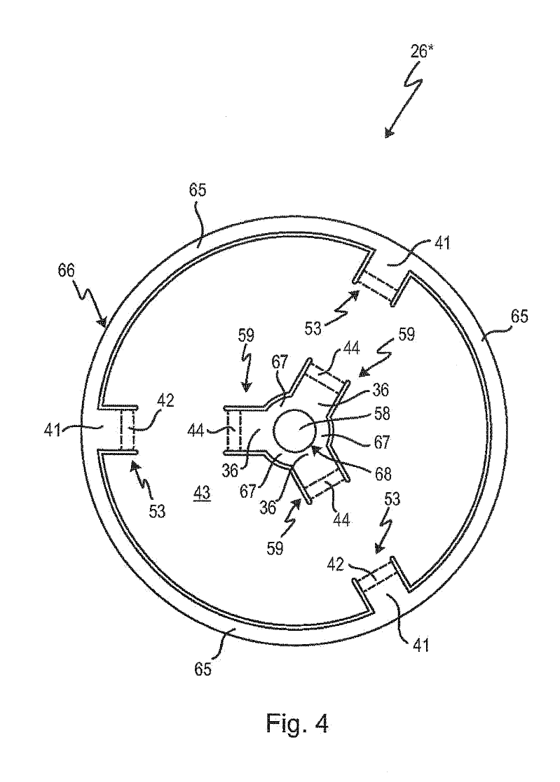

In the embodiment shown in FIG. 4, the spring snap-action disc 26 has in total three webs 53, which are arranged distributed around the rim 27 with a uniform distribution at 120° with respect to one another. Each web 53 has the outer contact region 41 radially on the outside, which contact region 41 extends radially outwards over the rim 27.

The web is separated on its sides 54 and 55 by a slit or notch 56 or 57 from the spring snap-action disc 26, with the result that it is connected to the central region 43 only via the compensation section 42.

The spring snap-action disc 26 is fixedly clamped on the second contact surface 39 only via the three outer contact regions 41.

When the spring snap-action disc 26 snaps over, the three compensation sections 42 perform a compensating movement, as has been described with reference to FIG. 2, with the result that the central region 43 can expand radially.

In its center, the spring snap-action disc 26 has a central hole 58, through which the movable contact part 25 protrudes with its pin 30. Three webs 59 protrude radially inwards into the central hole 58, which three webs each have an inner contact region 36 radially on the inside.

Each web 59 is separated on its two sides 61 and 62 from the spring snap-action disc 26 by a slit or a notch 63 or 64, with the result that it is only connected to the central region 43 via the compensation section 44.

In the same way as the webs 53, the three webs 59 are also arranged distributed evenly at 120° with respect to one another, wherein a web 59 is radially opposite each web 53.

In this way, the central region 43 can also expand radially inwards when the spring snap-action disc 26 snaps over, which likewise reduces the mechanical loading during snap-over.

The spring snap-action disc 26 can also be provided only with the webs 53 or only with the webs 59, wherein it is also possible for more than three webs 53 and/or 59 to be provided.

The compensation sections 42 and 44 can in this case each be designed as illustrated in FIG. 2.

FIG. 4 illustrates a further embodiment of the spring snap-action disc 26′, in which the inner webs 59 are designed as in FIG. 3. The outer webs 53 are also designed as in FIG. 3.

As a deviation from FIG. 3, the outer contact regions 41 are connected by three ring sections 65 circumferentially to form a closed ring 66, which overall acts as outer contact region 41.

Likewise, the inner contact regions 36 are connected by three ring sections 67 to form a closed ring 68, which overall acts as inner contact region 36.

The ring 66 is only connected to the central region 43 of the spring snap-action disc 26 via the three webs 53 and the compensation sections 42 thereof. Correspondingly, the ring 68 is only connected to the central region 43 of the spring snap-action disc 26 via the three webs 59 and the compensation sections 44 thereof.

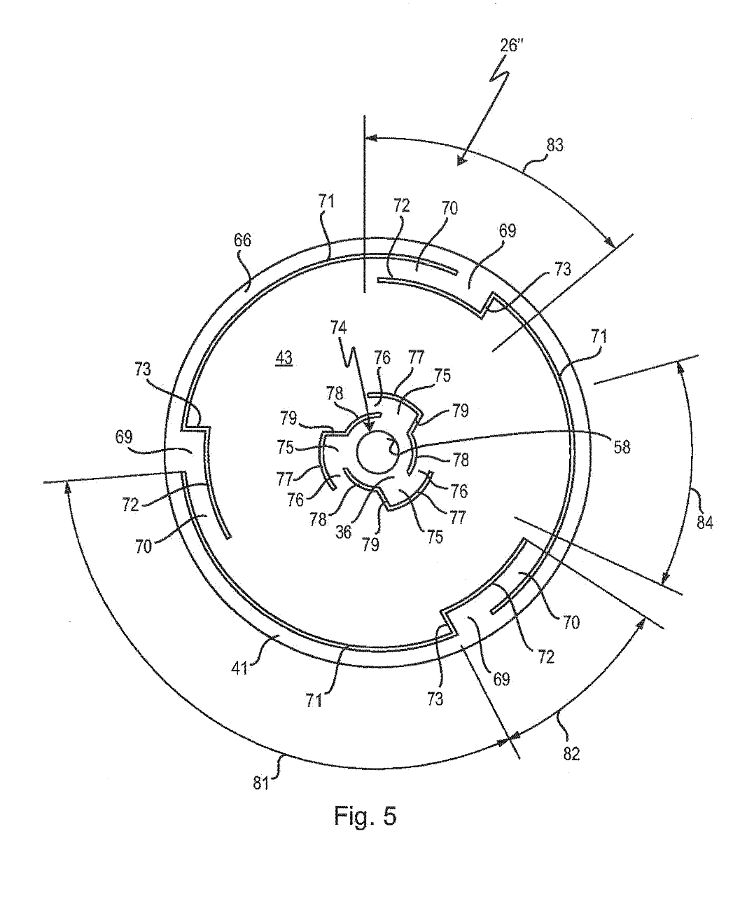

FIG. 5 shows a spring snap-action disc 26″, in which a peripheral ring 66 is likewise provided as outer contact region 41, which is connected to the central region 43 of the spring snap-action disc 26″ via three angled webs. Each angled web extends with its first section 69 radially from the ring 66 inwards and, adjoining this, with its longer section 70 in the circumferential direction.

Three outer slits 77 extending in the circumferential direction and three slits 72 lying further inwards and extending likewise in the circumferential direction are provided circumferentially between the ring 66 and the central region 43, wherein the slits 71, 72 partially overlap one another in the region of the longer section 69 in the circumferential direction and are connected to one another by slits 73 extending from the inside outwards.

A comparable structure is also provided in the center of the spring snap-action disc 26, where the inner contact region 36 is in the form of a ring 74, which is connected to the central region 43 via three angled webs. The three webs each have a first section 75, which extends radially from the ring 74 outwards, and an adjoining section 76, which extends in the circumferential direction.

Three outer slits 77 extending in the circumferential direction and, positioned further inwards, three slits 78 likewise extending in the circumferential direction are provided circumferentially between the ring 74 and the central region 43, wherein the slits 77, 78 partially overlap one another in the region of the section 76 in the circumferential direction and are connected to one another by slits 79 extending from the inside outwards.

The sections 69, 70 form, with the slits 71, 72, 73, in the same way as the sections 75, 76 with the slits 77, 78, 79, a compensation section.

These designs also enable the central region 43 to be deflected temporarily radially outwards and inwards when the spring snap-action disc 26 snaps over.

The outer slits 71 in this case cover an angular range 81 of 110°, while the inner slits 72 cover an angular range 82 of 35°, which is therefore less than half the size of the angular range 81.

The outer slits 77 finally cover an angular range 83 of 50°, while the inner slits 78 cover an angular range 84 of 40°, i.e. which is at most the same size as the angular range 83.

Therefore, what is claimed is:

1. A temperature-dependent switch with a first and a second external connection, comprising:
a temperature-dependent switching mechanism comprising a snap-action disc provided with at least one outer contact region and at least one inner contact region, a movable contact part being provided on said at least one inner contact region, and
a housing accommodating the switching mechanism and comprising an upper part having an inner side, and a lower part having an inside,
a first contact surface being provided on said inner side of said upper part and connected to said first external connection, and
a second contact surface being provided in said inside of said lower part and connected to said second external connection,
said movable contact part interacting with said first contact surface, said snap-action disc lifting off said movable contact part from said first contact surface depending on temperature, and
said at least one outer contact region or each outer contact region resting permanently to said second contact surface.

2. The switch of claim 1, wherein said snap-action disc comprises at least one compensation section arranged between the at least one or each outer contact region and the at least one or each inner contact region.

3. The switch of claim 1, wherein said snap-action disc is a spring snap-action disc and a bimetal snap-action disc is provided, said bimetal snap-action disc held with play on the movable contact part.

4. The switch of claim 3, wherein said bimetal snap-action disc is captively held on the movable contact part.

5. The switch of claim 3, wherein said bimetal snap-action disc is arranged between the spring snap-action disc and the first contact surface.

6. The switch of claim 3, wherein said spring snap-action disc comprises a first side pointing away from said first contact surface, said bimetal snap-action disc is arranged on said first side of said spring snap-action disc.

7. The switch of claim 1, wherein the outer contact region or each outer contact region is connected permanently to the second contact surface by means of clamping.

8. The switch of claim 1, wherein the movable contact part is clamped fixedly on the at least one inner contact region.

9. The switch of claim 2, wherein the compensation section or each compensation section is resilient in the radial direction.

10. The switch of claim 1, wherein the outer contact region or each outer contact region is formed on a radially extending web, which is connected to a central region of the snap-action disc via a compensation section.

11. The switch of claim 10, wherein the compensation section is embodied as an upwardly arched section provided between the outer contact region and the central region of the snap-action disc.

12. The switch of claim 10, wherein said web is connected to the central region of the snap-action disc exclusively via the compensation section.

13. The switch of claim 10, wherein at least three webs are provided, each web provided with an outer contact region.

14. The switch of claim 13, wherein the outer contact regions are connected to one another to form a ring.

15. The switch of claim 1, wherein the inner contact region or each inner contact region is formed on a radially extending web, which web is connected to a central region of the snap-action disc via a compensation section.

16. The switch of claim 15, wherein the compensation section is embodied as an upwardly arched section provided between the inner contact region and the central region of the snap-action disc.

17. The switch of claim 15, wherein said web is connected to the central region of the snap-action disc exclusively via said compensation section.

18. The switch of claim 15, wherein at least three webs are provided, each web provided with an inner contact region.

19. The switch of claim 18, wherein the inner contact regions are connected to one another to form a ring.

20. The switch of claim 1, wherein said outer contact region is in the form of a closed ring, which ring is connected to a central region of the snap-action disc via a compensation section, wherein the compensation section has at least one outer slit extending in the circumferential direction and at least one inner slit extending in the circumferential direction, wherein the outer and inner slits partially overlap one another in the circumferential direction.

21. The switch of claim 20, wherein said inner and outer slits are connected to one another by a radially extending slit.

22. The switch of claim 20, wherein at least three outer and three inner slits are provided.

23. The switch of claim 20, wherein the inner slit extends over an angular range which is less than half the size of the angular range over which the outer slit extends.

24. The switch of claim 1, wherein the inner contact region is in the form of a closed ring, which ring is connected to a central region of the snap-action disc via a compensation section, wherein the compensation section has at least one outer slit extending in the circumferential direction and at least one inner slit extending in the circumferential direction, wherein the inner and outer slits partially overlap one another in the circumferential direction.

25. The switch of claim 24, wherein the inner and outer slits are connected to one another by a radially extending slit.

26. The switch of claim 24, wherein at least three outer and three inner slits are provided.

27. The switch of claim 24, wherein said inner slit extends over an angular range which is less than the angular range over which the outer slit extends.

28. A temperature-dependent switch with a first and a second external connection, comprising:
a temperature-dependent switching mechanism comprising a snap-action disc provided with at least one outer contact region and at least one inner contact region, a movable contact part being provided on said at least one inner contact region, and
a housing accommodating the switching mechanism and comprising an upper part having an inner side, and a lower part having an inside,
a first contact surface being provided on said inner side of said upper part and connected to said first external connection, and
a second contact surface being provided in said inside of said lower part and connected to said second external connection,
said movable contact part interacting with said first contact surface, said snap-action disc lifting off said movable contact part from said first contact surface depending on temperature,
said at least one outer contact region being permanently connected to said second contact surface at least in sections, and
said snap-action disc comprising at least one compensation section between the at least one outer contact region and the at least one inner contact region.

29. The switch of claim 28, wherein said snap-action disc includes a radial direction and the compensation section is resilient in said radial direction.

30. The switch of claim 29, wherein said a least one outer contact region is formed on a first web extending in said radial direction and connected to a central region of the snap-action disc via a first compensation section.

31. The switch of claim 30, wherein the inner contact region is formed on a second web extending in said radial direction and connected to a central region of the snap-action disc via a second compensation section.
